(19) United States
(12) Patent Application Publication
(10) Pub. No.: US 2025/0337899 A1
(43) Pub. Date: Oct. 30, 2025

(54) METHOD, APPARATUS, AND MEDIUM FOR VIDEO PROCESSING

(71) Applicants: Douyin Vision Co., Ltd., Beijing (CN); Bytedance Inc, Los Angeles, CA (US)

(72) Inventors: Junru LI, Beijing (CN); Kai ZHANG, Los Angeles, CA (US); Ye-Kui WANG, Los Angeles, CA (US); Yue LI, Los Angeles, CA (US); Chaoyi LIN, Beijing (CN); Jizheng XU, Los Angeles, CA (US); Li ZHANG, Los Angeles, CA (US)

(21) Appl. No.: 19/261,728

(22) Filed: Jul. 7, 2025

Related U.S. Application Data
(63) Continuation of application No. PCT/CN2024/070963, filed on Jan. 5, 2024.

(30) Foreign Application Priority Data
Jan. 7, 2023 (WO) PCT/CN2023/071124

(51) Int. Cl. H04N 19/117; H04N 19/124; H04N 19/172; H04N 19/174; H04N 19/31; H04N 19/70; H04N 19/82

(52) U.S. Cl. CPC H04N 19/117; H04N 19/124; H04N 19/172; H04N 19/174; H04N 19/31; H04N 19/70; H04N 19/82

(57) ABSTRACT

Embodiments of the disclosure provide a solution for video processing. A method for video processing is proposed. The method includes: determining, for a conversion between a video unit of a video and a bitstream of the video, which video unit is specified to be an input video unit of a filtering procedure that is applied to a current video unit; and performing the conversion based on the filtering procedure.

### CROSS REFERENCE

This application is a continuation of International Application No. PCT/CN2024/070963, filed on Jan. 5, 2024, which claims the benefits of International Application No. PCT/CN2023/071124, filed on Jan. 7, 2023. The entire contents of these applications are hereby incorporated by reference in their entireties.

### FIELDS

Embodiments of the present disclosure relates generally to video processing techniques, and more particularly, to provide post-filtered input signals.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, which video unit is specified to be an input video unit of a filtering procedure that is applied to a current video unit; and performing the conversion based on the filtering procedure. The method in accordance with the first aspect of the present disclosure may improve coding efficiency and coding performance.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining which video unit is specified to be an input video unit of a filtering procedure that is applied to a current video unit of the video; and generating the bitstream based on the filtering procedure.

In a fifth aspect, a method for storing a bitstream of a video is proposed. The method comprises: determining which video unit is specified to be an input video unit of a filtering procedure that is applied to a current video unit of the video; generating the bitstream based on the filtering procedure; and storing the bitstream in a non-transitory computer-readable medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates the derivation of the four luma channels (right) from the luma component (left) when nnpfc_inp_order_idc is equal to 3;

FIG. 5 illustrates a flowchart of a method for video processing in accordance with embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

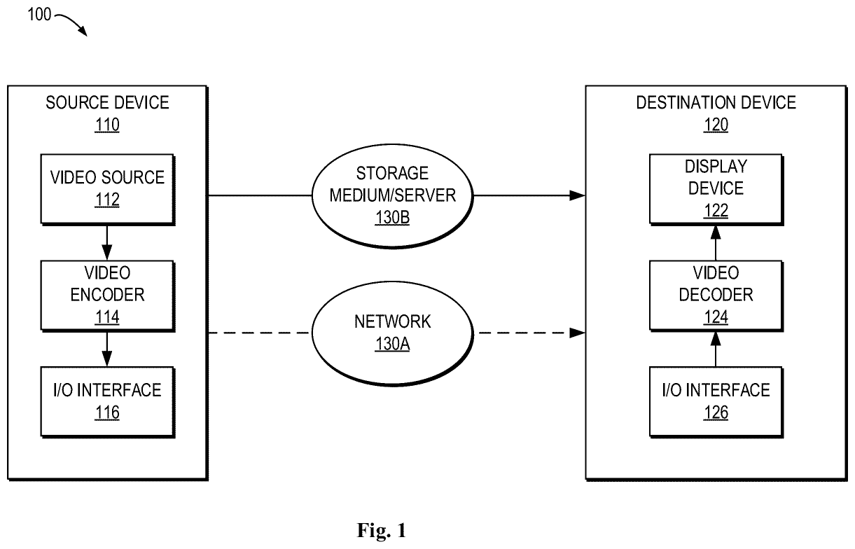

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

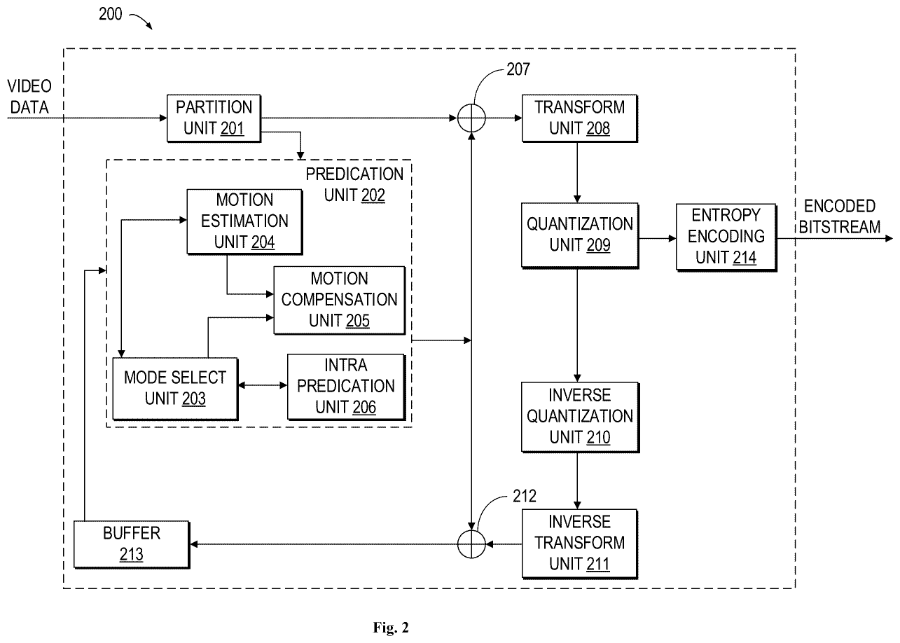

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components.

The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

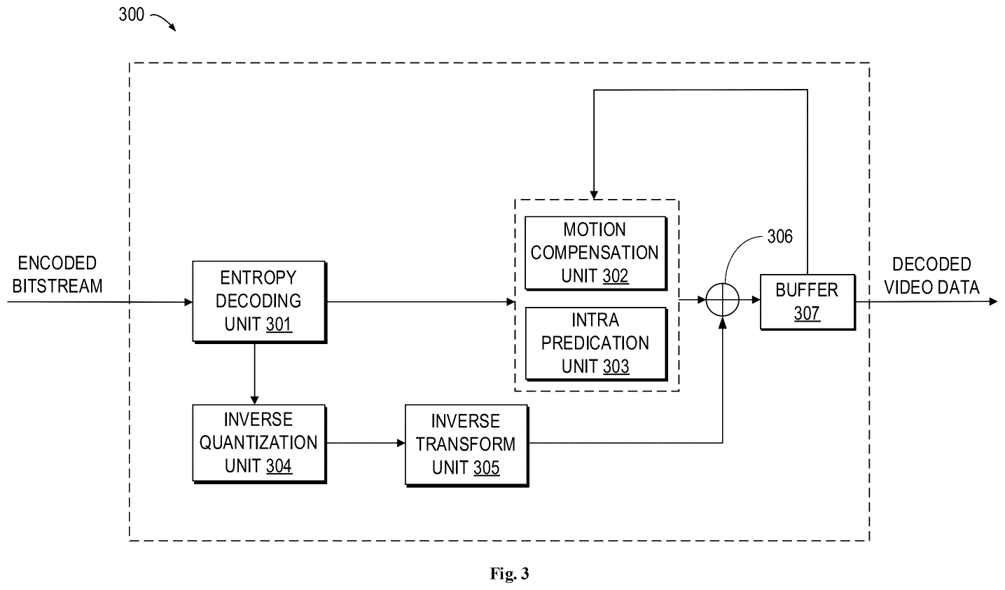

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This present disclosure is related to image/video coding technologies. Specifically, it is related to the definition and signalling of post-processing filtering, such as new neural-network post-processing filtering purposes, as well as their combinations with the current purposes. The ideas may be applied individually or in various combinations, for video bitstreams coded by any codec, e.g., the versatile video coding (VVC) standard and/or the versatile SEI messages for coded video bitstreams (VSEI) standard.

### 2. Abbreviations

APS Adaptation Parameter Set
AU Access Unit
CLVS Coded Layer Video Sequence
CLVSS Coded Layer Video Sequence Start
CRC Cyclic Redundancy Check
CVS Coded Video Sequence
FIR Finite Impulse Response
IRAP Intra Random Access Point
NAL Network Abstraction Layer
PPS Picture Parameter Set
PU Picture Unit
RASL Random Access Skipped Leading
SEI Supplemental Enhancement Information
STSA Step-wise Temporal Sublayer Access
VCL Video Coding Layer
VSEI versatile supplemental enhancement information (Rec. ITU-T H.274 ISO/IEC 23002-7)
VUI Video Usability Information
VVC versatile video coding (Rec. ITU-T H.266|ISO/IEC 23090-3)

### 3. Introduction

### 3.1. Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure where temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266 ISO/IEC 23090-3) and the associated Versatile Supplemental Enhancement Information for coded video bitstreams (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 3.2. SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274 ISO/IEC 23002-7.

### 3.3. Signalling of Neural-Network Post-Filters

WG 05 output document N0158 and JVET-AB2006 include the specification of two SEI messages for signalling of neural-network post-filters, as follows.

### 8.28 Neural-Network Post-Filter Characteristics SEI Message

### 8.28.1 Neural-Network Post-Filter Characteristics SEI Message Syntax

| | Descriptor |
|---|---|
| nn_post_filter_characteristics( payloadSize ) { | |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_formatting_and_purpose_flag | u(1) |
| if( nnpfc_formatting_and_purpose_flag ) { | |
| nnpfc_purpose | ue(v) |
| /* input and output formatting */ | |
| if( nnpfc_purpose = = 2 \| \| nnpfc_purpose = = 4 ) | |
| nnpfc_out_sub_c_flag | u(1) |
| else if( nnpfc_purpose = = 3 \| \| nnpfc_purpose = = 4 ) { | |
| nnpfc_pic_width_in_luma_samples | ue(v) |
| nnpfc_pic_height_in_luma_samples | ue(v) |
| } | |
| else if( nnpfc_purpose = = 5 ) { | |
| nnpfc_num_input_pics_minus2 | ue(v) |
| for( i = 0; i <= nnpfc_num_input_pics_minus2; i++ ) | |
| nnpfc_interpolated_pics[ i ] | ue(v) |
| } | |
| nnpfc_component_last_flag | u(1) |
| nnpfc_inp_format_idc | ue(v) |
| if( nnpfc_inp_format_idc = = 1 ) | |
| nnpfc_inp_tensor_bitdepth_minus8 | ue(v) |
| nnpfc_inp_order_idc | ue(v) |
| nnpfc_auxiliary_inp_idc | ue(v) |
| nnpfc_separate_colour_description_present_flag | u(1) |
| if( nnpfc_separate_colour_description_present_flag ) { | |
| nnpfc_colour_primaries | u(8) |
| nnpfc_transfer_characteristics | u(8) |
| nnpfc_matrix_coeffs | u(8) |
| } | |
| nnpfc_out_format_idc | ue(v) |
| if( nnpfc_out_format_idc = = 1 ) | |
| nnpfc_out_tensor_bitdepth_minus8 | ue(v) |
| nnpfc_out_order_idc | ue(v) |
| nnpfc_constant_patch_size_flag | u(1) |
| nnpfc_patch_width_minus1 | ue(v) |
| nnpfc_patch_height_minus1 | ue(v) |
| nnpfc_overlap | ue(v) |
| nnpfc_padding_type | ue(v) |
| if( nnpfc_padding_type = = 4 ) { | |
| nnpfc_luma_padding_val | ue(v) |
| nnpfc_cb_padding_val | ue(v) |
| nnpfc_cr_padding_val | ue(v) |
| } | |
| nnpfc_complexity_info_present_flag | ue(v) |
| if( nnpfc_complexity_info_present_flag ) { | |
| nnpfc_parameter_type_idc | u(2) |
| if( nnpfc_parameter_type_idc != 2 ) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| } | |
| /* ISO/IEC 15938-17 bitstream */ | |
| if( nnpfc_mode_idc = = 0 ) { | |
| while( !byte_aligned( ) ) | |
| nnpfc_reserved_zero_bit_b | u(1) |
| for( i = 0; more_data_in_payload( ); i++ ) | |
| nnpfc_payload_byte[ i ] | b(8) |
| } | |
| } | |

### 8.28.2 Neural-Network Post-Filter Characteristics SEI Message Semantics

The neural-network post-filter characteristics (NNPFC) SEI message specifies a neural network that may be used as a post-processing filter. The use of specified post-processing filters for specific pictures is indicated with neural-network post-filter activation SEI messages.

Use of this SEI message requires the definition of the following variables:
Cropped decoded output picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the cropped decoded output pictures with idx in the range of 0 to numInputPics−1, inclusive, that are used as input for the post-processing filter.
Bit depth BitDepthY for the luma sample array of the cropped decoded output pictures.
Bit depth BitDepthC for the chroma sample arrays, if any, of the cropped decoded output pictures.
A chroma format indicator, denoted herein by ChromaFormatIdc, as described in subclause 7.3.
When nnpfc_auxiliary_inp_idc is equal to 1, a filtering strength control value StrengthControlVal that shall be a real number in the range of 0 to 1, inclusive.

The variables SubWidthC and SubHeightC are derived from ChromaFormatIdc as specified by Table 2.
NOTE 1—More than one NNPFC SEI message can be present for the same picture. When more than one NNPFC SEI message with different values of nnpfc_id is present or activated for the same picture, they can have the same or different values of nnpfc_purpose and nnpfc_mode_idc.

nnpfc_id contains an identifying number that may be used to identify a post-processing filter. The value of nnpfc_id shall be in the range of 0 to 232-2, inclusive. Values of nnpfc_id from 256 to 511, inclusive, and from 231 to 232-2, inclusive, are reserved for future use by ITU-T|ISO/JEC. Decoders conforming to this edition of this document encountering an NNPFC SEI message with nnpfc_id in the range of 256 to 511, inclusive, or in the range of 231 to 232-2, inclusive, shall ignore the SEI message.

When an NNPFC SEI message is the first NNPFC SEI message, in decoding order, that has a particular nnpfc_id value within the current CLVS, the following applies:
This SEI message specifies a base post-processing filter.
This SEI message pertains to the current decoded picture and all subsequent decoded pictures of the current layer, in output order, until the end of the current CLVS.

When an NNPFC SEI message is a repetition of a previous NNPFC SEI message, in decoding order, in the current CLVS, the subsequent semantics apply as if this SEI message were the only NNPFC SEI message having the same content within the current CLVS.

When an NNPFC SEI message is not the first NNPFC SEI message, in decoding order, that has a particular nnpfc_id value within the current CLVS, the following applies:
This SEI message defines an update relative to the preceding base post-processing filter in decoding order with the same nnpfc_id value.
This SEI message pertains to the current decoded picture and all subsequent decoded pictures of the current layer, in output order, until the end of the current CLVS or the next NNPFC SEI message having that particular nnpfc_id value, in output order, within the current CLVS.

nnpfc_mode_idc equal to 0 indicates that this SEI message contains an ISO/JEC 15938-17 bitstream that specifies a base post-processing filter or is an update relative to the base post-processing filter with the same nnpfc_id value.

When an NNPFC SEI message is the first NNPFC SEI message, in decoding order, that has a particular nnpfc_id value within the current CLVS, nnpfc_mode_idc equal to 1 specifies that the base post-processing filter associated with the nnpfc_id value is a neural network identified by the URI indicated by nnpfc_uri with the format identified by the tag URI nnpfc_tag_uri.

When an NNPFC SEI message is not the first NNPFC SEI message, in decoding order, that has a particular nnpfc_id value within the current CLVS, nnpfc_mode_idc equal to 1 specifies that an update relative to the base post-processing filter with the same nnpfc_id value is defined by the URI indicated by nnpfc_uri with the format identified by the tag URI nnpfc_tag_uri.

The value of nnpfc_mode_idc shall be in the range of 0 to 1, inclusive, in bitstreams conforming to this edition of this document. Values of 2 to 255, inclusive, for nnpfc_mode_idc are reserved for future use by ITU-T|ISO/JEC and shall not be present in bitstreams conforming to this edition of this document. Decoders conforming to this edition of this document shall ignore NNPFC SEI messages with nnpfc_mode_idc in the range of 2 to 255, inclusive. Values of nnpfc_mode_idc greater than 255 shall not be present in bitstreams conforming to this edition of this document and are not reserved for future use.

When this SEI message is the first NNPFC SEI message, in decoding order, that has a particular nnpfc_id value within the current CLVS, the post-processing filter PostProcessingFilter( ) is assigned to be the same as the base post-processing filter.

When this SEI message is not the first NNPFC SEI message, in decoding order, that has a particular nnpfc_id value within the current CLVS, a post-processing filter PostProcessingFilter( ) is obtained by applying the update defined by this SEI message to the base post-processing filter.

Updates are not cumulative but rather each update is applied on the base post-processing filter, which is the post-processing filter specified by the first NNPFC SEI message, in decoding order, that has a particular nnpfc_id value within the current CLVS.

nnpfc_reserved_zero_bit_a shall be equal to 0 in bitstreams conforming to this edition of this document. Decoders shall ignore NNPFC SEI messages in which nnpfc_reserved_zero_bit_a is not equal to 0.

nnpfc_tag_uri contains a tag URI with syntax and semantics as specified in IETF RFC 4151 identifying the format and associated information about the neural network used as a base post-processing filter or an update relative to the base post-processing filter with the same nnpfc_id value specified by nnpfc_uri.
NOTE 2—nnpfc_tag_uri enables uniquely identifying the format of neural network data specified by nnrpf_uri without needing a central registration authority.

nnpfc_tag_uri equal to “tag:iso.org.2023:15938-17” indicates that the neural network data identified by nnpfc_uri conforms to ISO/JEC 15938-17.

nnpfc_uri contains a URI with syntax and semantics as specified in IETF Internet Standard 66 identifying the neural network used as a base post-processing filter or an update relative to the base post-processing filter with the same nnpfc_id value.

nnpfc_formatting_and_purpose_flag equal to 1 specifies that syntax elements related to the filter purpose, input formatting, output formatting, and complexity are present. nnpfc_formatting_and_purpose_flag equal to 0 specifies that no syntax elements related to the filter purpose, input formatting, output formatting, and complexity are present.

When this SEI message is the first NNPFC SEI message, in decoding order, that has a particular nnpfc_id value within the current CLVS, nnpfc_formatting_and_purpose_flag shall be equal to 1. When this SEI message is not the first NNPFC SEI message, in decoding order, that has a particular nnpfc_id value within the current CLVS, nnpfc_formatting_and_purpose_flag shall be equal to 0.

nnpfc_purpose indicates the purpose of the post-processing filter as specified in Table 2-1.

The value of nnpfc_purpose shall be in the range of 0 to 5, inclusive, in bitstreams conforming to this edition of this document. Values of 6 to 1023, inclusive, for nnpfc_purpose are reserved for future use by ITU-T|ISO/JEC and shall not be present in bitstreams conforming to this edition of this document. Decoders conforming to this edition of this document shall ignore NNPFC SEI messages with nnpfc_purpose in the range of 6 to 1203, inclusive. Values of nnpfc_purpose greater than 1023 shall not be present in bitstreams conforming to this edition of this document and are not reserved for future use.

TABLE 2-1
Definition of nnpfc_purpose

| Value | Interpretation |
|---|---|
| 0 | May be used as determined by the application |
| 1 | Visual quality improvement |
| 2 | Chroma upsampling from the 4:2:0 chroma format to the 4:2:2 or |
| | 4:4:4 chroma format, or from the 4:2:2 chroma format to the |
| | 4:4:4 chroma format |
| 3 | Increasing the width or height of the cropped decoded output |
| | picture without changing the chroma format |
| 4 | Increasing the width or height of the cropped decoded output |
| | picture and upsampling the chroma format |
| 5 | Picture rate upsampling |

NOTE 3—When a reserved value of nnpfc_purpose is taken into use in the future by ITU-T|ISO/JEC, the syntax of this SEI message could be extended with syntax elements whose presence is conditioned by nnpfc_purpose being equal to that value.

When SubWidthC is equal to 1 and SubHeightC is equal to 1, nnpfc_purpose shall not be equal to 2 or 4.

nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When nnpfc_out_sub_c_flag is not present, outSubWidthC is inferred to be equal to SubWidthC and outSubHeightC is inferred to be equal to SubHeightC. When ChromaFormatIdc is equal to 2 and nnpfc_out_sub_c_flag is present, the value of nnpfc_out_sub_c_flag shall be equal to 1.

nnpfc_pic_width_in_luma_samples and nnpfc_pic_height_in_luma_samples specify the width and height, respectively, of the luma sample array of the picture resulting from applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

nnpfc_num_input_pics_minus2 plus 2 specifies the number of decoded output pictures used as input for the post-processing filter.

nnpfc_interpolated_pics[i] specifies the number of interpolated pictures generated by the post-processing filter between the i-th and the (i+1)-th picture used as input for the post-processing filter.

The variables numInputPics, specifying the number of pictures used as input for the post-processing filter, and numOutputPics, specifying the total number of pictures resulting from the post-processing filter, are derived as follows:

if( nnpfc_purpose = = 5 ) {
numInputPics = nnpfc_num_input_pics_minus2 + 2

| | |
|---|---|
| for( i = 0, numOutputPics = 0; i <= numInputPics − 2; i++ ) | (76) |

```
    numOutputPics += nnpfc_interpolated_pics[ i ]
} else
  numInputPics = 1
```

nnpfc_component_last_flag equal to 1 indicates that the last dimension in the input tensor inputTensor to the post-processing filter and the output tensor outputTensor resulting from the post-processing filter is used for a current channel. nnpfc_component_last_flag equal to 0 indicates that the third dimension in the input tensor inputTensor to the post-processing filter and the output tensor outputTensor resulting from the post-processing filter is used for a current channel.
NOTE 4—The first dimension in the input tensor and in the output tensor is used for the batch index, which is a practice in some neural network frameworks. While formulae in the semantics of this SEI message use the batch size corresponding to the batch index equal to 0, it is up to the post-processing implementation to determine the batch size used as input to the neural network inference.
NOTE 5—For example, when nnpfc_inp_order_idc is equal to 3 and nnpfc_auxiliary_inp_idc is equal to 1, there are 7 channels in the input tensor, including four luma matrices, two chroma matrices, and one auxiliary input matrix. In this case, the process DeriveInputTensors( ) would derive each of these 7 channels of the input tensor one by one, and when a particular channel of these channels is processed, that channel is referred to as the current channel during the process.

nnpfc_inp_format_idc indicates the method of converting a sample value of the cropped decoded output picture to an input value to the post-processing filter. When nnpfc_inp_format_idc is equal to 0, the input values to the post-processing filter are real numbers and the functions InpY( ) and InpC( ) are specified as follows:

$$InpY ( x ) = x \div ( ( 1 ≪ BitDepthY ) - 1 ) \qquad ( 77 )$$

$$InpC ( x ) = x \div ( ( 1 ≪ BitDepthC ) - 1 ) . \qquad ( 78 )$$

When nnpfc_inp_format_idc is equal to 1, the input values to the post-processing filter are unsigned integer numbers and the functions InpY( ) and InpC( ) are specified as follows:

shiftY = BitDepth_{Y} − inpTensorBitDepth
if( inpTensorBitDepth >= BitDepth_{Y})

| | |
|---|---|
| InpY( x ) = x << ( inpTensorBitDepth − BitDepth_{Y} ) | (79) |

else
InpY( x ) = Clip3(0, ( 1 << inpTensorBitDepth ) − 1, ( x + ( 1 << ( shiftY −
1 ) ) ) >> shiftY )
shiftC = BitDepth_{C} − inpTensorBitDepth
if( inpTensorBitDepth >= BitDepth_{C} )

| | |
|---|---|
| InpC( x ) = x << ( inpTensorBitDepth − BitDepth_{C} ) | (80) |

else
InpC( x ) = Clip3(0, ( 1 << inpTensorBitDepth ) − 1, ( x + ( 1 << ( shiftC −
1 ) ) ) >> shiftC ).

The variable inpTensorBitDepth is derived from the syntax element nnpfc_inp_tensor_bitdepth_minus8 as specified below.

Values of nnpfc_inp_format_idc greater than 1 are reserved for future specification by ITU-T|ISO/JEC and shall not be present in bitstreams conforming to this edition of this document. Decoders conforming to this edition of this document shall ignore NNPFC SEI messages that contain reserved values of nnpfc_inp_format_idc.

nnpfc_inp_tensor_bitdepth_minus8 plus 8 specifies the bit depth of luma sample values in the input integer tensor. The value of inpTensorBitDepth is derived as follows:

$$inpTensorBitDepth = nnpfc\_inp \_tensor \_bitdepth \_minus8 + 8. \qquad ( 81 )$$

It is a requirement of bitstream conformance that the value of nnpfc_inp_tensor_bitdepth_minus8 shall be in the range of 0 to 24, inclusive.

nnpfc_inp_order_idc indicates the method of ordering the sample arrays of a cropped decoded output picture as one of the input pictures to the post-processing filter.

The value of nnpfc_inp_order_idc shall be in the range of 0 to 3, inclusive, in bitstreams conforming to this edition of this document. Values of 4 to 255, inclusive, for nnpfc_inp_order_idc are reserved for future use by ITU-T|ISO/JEC and shall not be present in bitstreams conforming to this edition of this document. Decoders conforming to this edition of this document shall ignore NNPFC SEI messages with nnpfc_inp_order_idc in the range of 4 to 255, inclusive. Values of nnpfc_inp_order_idc greater than 255 shall not be present in bitstreams conforming to this edition of this document and are not reserved for future use.

When ChromaFormatldc is not equal to 1, nnpfc_inp_order_idc shall not be equal to 3.

Table 2-2 contains an informative description of nnpfc_inp_order_idc values.

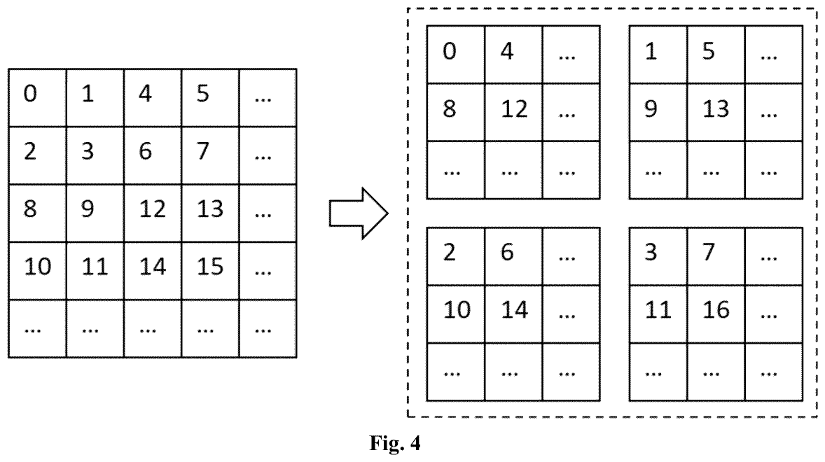

TABLE 2-2
Description of nnpfc_inp_order_idc values

| nnpfc_inp_order_idc | Description |
|---|---|
| 0 | If nnpfc_auxiliary_inp_idc is equal to 0, one luma matrix is present in the input tensor |
| | for each input picture, and the number of channels is 1. Otherwise when |
| | nnpfc_auxiliary_inp_idc is equal to 1, one luma matrix and one auxiliary input matrix are |
| | present, and the number of channels is 2. |
| 1 | If nnpfc_auxiliary_inp_idc is equal to 0, two chroma matrices are present in the input |
| | tensor, and the number of channels is 2. Otherwise when nnpfc_auxiliary_inp_idc is |
| | equal to 1, two chroma matrices and one auxiliary input matrix are present, and the |
| | number of channels is 3. |
| 2 | If nnpfc_auxiliary_inp_idc is equal to 0, one luma and two chroma matrices are present |
| | in the input tensor, and the number of channels is 3. Otherwise when |
| | nnpfc_auxiliary_inp_idc is equal to 1, one luma matrix, two chroma matrices and one |
| | auxiliary input matrix are present, and the number of channels is 4. |
| 3 | If nnpfc_auxiliary_inp_idc is equal to 0, four luma matrices and two chroma matrices are |
| | present in the input tensor, and the number of channels is 6. Otherwise when |
| | nnpfc_auxiliary_inp_idc is equal to 1, four luma matrices, two chroma matrices, and one |
| | auxiliary input matrix are present in the input tensor, and the number of channels is 7. |
| | The luma channels are derived in an interleaved manner as illustrated in FIG. 4. This |
| | nnpfc_inp_order_idc can only be used when the chroma format is 4:2:0. |
| 4 . . . 255 | Reserved |

FIG. 4 illustrates the derivation of the four luma channels (right) from the luma component (left) when nnpfc_inp_order_idc is equal to 3.

A patch is a rectangular array of samples from a component (e.g., a luma or chroma component) of a picture.

nnpfc_auxiliary_inp_idc greater than 0 indicates that auxiliary input data is present in the input tensor of the neural-network post-filter. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 82.

The value of nnpfc_auxiliary_inp_idc shall be in the range of 0 to 1, inclusive, in bitstreams conforming to this edition of this document. Values of 2 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 2 to 255, inclusive. Values of nnpfc_inp_order_idc greater than 255 shall not be present in bitstreams conforming to this edition of this document and are not reserved for future use.

The process DeriveInputTensors( ), for deriving the input tensor inputTensor for a given vertical sample coordinate cTop and a horizontal sample coordinate cLeft specifying the top-left sample location for the patch of samples included in the input tensor, is specified as follows:

```
for( i = 0; i < numInputPics; i++ ) {
  if( nnpfc_inp_order_idc = = 0 )
    for( yP = −overlapSize; yP < inpPatchHeight + overlapSize; yP++)
      for( xP = −overlapSize; xP < inpPatchWidth + overlapSize; xP++ ) {
        inpVal = InpY( InpSampleVal( cTop + yP, cLeft + xP, CroppedHeight,
            CroppedWidth, CroppedYPic[ i ] ) )
        if( !nnpfc_component_last_flag )
          inputTensor[ 0 ][ i ][ 0 ][ yP + overlapSize ][ xP + overlapSize ] = inpVal
        else
          inputTensor[ 0 ][ i ][ yP + overlapSize ][ xP + overlapSize ][ 0 ] = inpVal
        if( nnpfc_auxiliary_inp_idc = = 1 )
          if( !nnpfc_component_last_flag )
            inputTensor[ 0 ][ i ][ 1 ][ yP + overlapSize ][ xP + overlapSize ] = StrengthControlVal
          else
            inputTensor[ 0 ][ i ][ yP + overlapSize ][ xP + overlapSize ][ 1 ] = StrengthControlVal
      }
```

| | |
|---|---|
| else if( nnpfc_inp_order_idc = = 1 ) | (82) |

```
    for( yP = −overlapSize; yP < inpPatchHeight + overlapSize; yP++)
      for( xP = −overlapSize; xP < inpPatchWidth + overlapSize; xP++ ) {
        inpCbVal = InpC( InpSampleVal( cTop+ yP, cLeft + xP, CroppedHeight / SubHeightC,
            CroppedWidth / SubWidthC, CroppedCbPic[ i ] ) )
        inpCrVal = InpC( InpSampleVal( cTop + yP, cLeft + xP, CroppedHeight / SubHeightC,
            CroppedWidth / SubWidthC, CroppedCrPic[ i ] ) )
        if( !nnpfc_component_last_flag ) {
          inputTensor[ 0 ][ i ][ 0 ][ yP + overlapSize ][ xP + overlapSize ] = inpCbVal
          inputTensor[ 0 ][ i ][ 1 ][ yP + overlapSize ][ xP + overlapSize ] = inpCrVal
        } else {
          inputTensor[ 0 ][ i ][ yP + overlapSize ][ xP + overlapSize ][ 0 ] = inpCbVal
          inputTensor[ 0 ][ i ][ yP + overlapSize ][ xP + overlapSize ][ 1 ] = inpCrVal
        }
        if( nnpfc_auxiliary_inp_idc = = 1 )
          if( !nnpfc_component_last_flag )
            inputTensor[ 0 ][ i ][ 2 ][ yP + overlapSize ][ xP + overlapSize ] = StrengthControlVal
          else
            inputTensor[ 0 ][ i ][ yP + overlapSize ][ xP + overlapSize ][ 2 ] = StrengthControlVal
      }
  else if( nnpfc_inp_order_idc = = 2 )
    for( yP = −overlapSize; yP < inpPatchHeight + overlapSize; yP++)
      for( xP = −overlapSize; xP < inpPatchWidth + overlapSize; xP++ ) {
        yY = cTop + yP
        xY = cLeft + xP
        yC = yY / SubHeightC
        xC = xY / SubWidthC
        inpYVal = InpY( InpSampleVal( yY, xY, CroppedHeight,
            CroppedWidth, CroppedYPic[ i ] ) )
        inpCbVal = InpC( InpSampleVal( yC, xC, CroppedHeight / SubHeightC,
            CroppedWidth / SubWidthC, CroppedCbPic[ i ] ) )
        inpCrVal = InpC( InpSampleVal( yC, xC, CroppedHeight / SubHeightC,
            CroppedWidth / SubWidthC, CroppedCrPic[ i ] ) )
        if( !nnpfc_component_last_flag ) {
          inputTensor[ 0 ][ i ][ 0 ][ yP + overlapSize ][ xP + overlapSize ] = inp YVal
          inputTensor[ 0 ][ i ][ 1 ][ yP + overlapSize ][ xP + overlapSize ] = inpCbVal
          inputTensor[ 0 ][ i ][ 2 ][ yP + overlapSize ][ xP + overlapSize ] = inpCrVal
        } else {
          inputTensor[ 0 ][ i ][ yP + overlapSize ][ xP + overlapSize ][ 0 ] = inpYVal
          inputTensor[ 0 ][ i ][ yP + overlapSize ][ xP + overlapSize ][ 1 ] = inpCbVal
          inputTensor[ 0 ][ i ][ yP + overlapSize ][ xP + overlapSize ][ 2 ] = inpCrVal
        }
        if( nnpfc_auxiliary_inp_idc = = 1 )
          if( !nnpfc_component_last_flag )
            inputTensor[ 0 ][ i ][ 3 ][ yP + overlapSize ][ xP + overlapSize ] = StrengthControlVal
          else
            inputTensor[ 0 ][ i ][ yP + overlapSize ][ xP + overlapSize ][ 3 ] = StrengthControlVal
      }
  else if( nnpfc_inp_order_idc = = 3 )
    for( yP = −overlapSize; yP < inpPatchHeight + overlapSize; yP++)
      for( xP = −overlapSize; xP < inpPatchWidth + overlapSize; xP++ ) {
        yTL = cTop + yP *2
        xTL = cLeft + xP * 2
        yBR = yTL + 1
        xBR = xTL + 1
        yC = cTop / 2 + yP
        xC = cLeft / 2 + xP
        inpTLVal = InpY( InpSampleVal( yTL, xTL, CroppedHeight,
            CroppedWidth, CroppedYPic[ i ] ) )
        inpTRVal = InpY( InpSampleVal( yTL, xBR, CroppedHeight,
            CroppedWidth, CroppedYPic[ i ] ) )
        inpBLVal = InpY( InpSampleVal( yBR, xTL, CroppedHeight,
            CroppedWidth, CroppedYPic[ i ] ) )
        inpBRVal = InpY( InpSampleVal( yBR, xBR, CroppedHeight,
            CroppedWidth, CroppedYPic[ i ] ) )
        inpCbVal = InpC( InpSampleVal( yC, xC, CroppedHeight / 2,
            CroppedWidth / 2, CroppedCbPic[ i ] ) )
        inpCrVal = InpC( InpSampleVal( yC, xC, CroppedHeight / 2,
            CroppedWidth / 2, CroppedCrPic[ i ] ) )
        if( !nnpfc_component_last_flag ) {
          inputTensor[ 0 ][ i ][ 0 ][ yP + overlapSize ][ xP + overlapSize ] = inpTLVal
          inputTensor[ 0 ][ i ][ 1 ][ yP + overlapSize ][ xP + overlapSize ] = inpTRVal
          inputTensor[ 0 ][ i ][ 2 ][ yP + overlapSize ][ xP + overlapSize ] = inpBLVal
          inputTensor[ 0 ][ i ][ 3 ][ yP + overlapSize ][ xP + overlapSize ] = inpBRVal
          inputTensor[ 0 ][ i ][ 4 ][ yP + overlapSize ][ xP + overlapSize ] = inpCbVal
          inputTensor[ 0 ][ i ][ 5 ][ yP + overlapSize ][ xP + overlapSize ] = inpCrVal
        } else {
          inputTensor[ 0 ][ i ][ yP + overlapSize ][ xP + overlapSize ][ 0 ] = inpTLVal
          inputTensor[ 0 ][ i ][ yP + overlapSize ][ xP + overlapSize ][ 1 ] = inpTRVal
          inputTensor[ 0 ][ i ][ yP + overlapSize ][ xP + overlapSize ][ 2 ] = inpBLVal
          inputTensor[ 0 ][ i ][ yP + overlapSize ][ xP + overlapSize ][ 3 ] = inpBRVal
          inputTensor[ 0 ][ i ][ yP + overlapSize ][ xP + overlapSize ][ 4 ] = inpCbVal
          inputTensor[ 0 ][ i ][ yP + overlapSize ][ xP + overlapSize ][ 5 ] = inpCrVal
        }
        if( nnpfc_auxiliary_inp_idc = = 1 )
          if( Innpfc_component_last_flag )
            inputTensor[ 0 ][ i ][ 6 ][ yP + overlapSize ][ xP + overlapSize ] = StrengthControlVal
          else
            inputTensor[ 0 ][ i ][ yP + overlapSize ][ xP + overlapSize ][ 6 ] = StrengthControlVal
      }
}.
```

nnpfc_separate_colour_description_present_flag equal to 1 indicates that a distinct combination of colour primaries, transfer characteristics, and matrix coefficients for the picture resulting from the post-processing filter is specified in the SEI message syntax structure. nnfpc_separate_colour_description_present_flag equal to 0 indicates that the combination of colour primaries, transfer characteristics, and matrix coefficients for the picture resulting from the post-processing filter is the same as indicated in VUI parameters for the CLVS.

nnpfc_colour_primaries has the same semantics as specified in subclause 7.3 for the vui_colour_primaries syntax element, except as follows:
nnpfc_colour_primaries specifies the colour primaries of the picture resulting from applying the neural-network post-filter specified in the SEI message, rather than the colour primaries used for the CLVS.
When nnpfc_colour_primaries is not present in the NNPFC SEI message, the value of nnpfc_colour_primaries is inferred to be equal to vui_colour_primaries.

nnpfc_transfer_characteristics has the same semantics as specified in subclause 7.3 for the vui_transfer_characteristics syntax element, except as follows:
nnpfc_transfer_characteristics specifies the transfer characteristics of the picture resulting from applying the neural-network post-filter specified in the SEI message, rather than the transfer characteristics used for the CLVS.
When nnpfc_transfer_characteristics is not present in the NNPFC SEI message, the value of nnpfc_transfer_characteristics is inferred to be equal to vui_transfer_characteristics.

nnpfc_matrix_coeffs has the same semantics as specified in subclause 7.3 for the vui_matrix_coeffs syntax element, except as follows:
nnpfc_matrix_coeffs specifies the matrix coefficients of the picture resulting from applying the neural-network post-filter specified in the SEI message, rather than the matrix coefficients used for the CLVS.
When nnpfc_matrix_coeffs is not present in the NNPFC SEI message, the value of nnpfc_matrix_coeffs is inferred to be equal to vui_matrix_coeffs.
The values allowed for nnpfc_matrix_coeffs are not constrained by the chroma format of the decoded video pictures that is indicated by the value of ChromaFormatIdc for the semantics of the VUI parameters.
When nnpfc_matrix_coeffs is equal to 0, nnpfc_out_order_idc shall not be equal to 1 or 3.

nnpfc_out_format_idc equal to 0 indicates that the sample values output by the post-processing filter are real numbers where the value range of 0 to 1, inclusive, maps linearly to the unsigned integer value range of 0 to (1<<bitDepth)−1, inclusive, for any desired bit depth bitDepth for subsequent post-processing or displaying.

nnpfc_out_format_flag equal to 1 indicates that the sample values output by the post-processing filter are unsigned integer numbers in the range of 0 to (1<<(nnpfc_out_tensor_bitdepth_minus8+8))−1, inclusive.

Values of nnpfc_out_format_idc greater than 1 are reserved for future specification by ITU-T|ISO/JEC and shall not be present in bitstreams conforming to this edition of this document. Decoders conforming to this edition of this document shall ignore NNPFC SEI messages that contain reserved values of nnpfc_out_format_idc.

nnpfc_out_tensor_bitdepth_minus8 plus 8 specifies the bit depth of sample values in the output integer tensor. The value of nnpfc_out_tensor_bitdepth_minus8 shall be in the range of 0 to 24, inclusive.

nnpfc_out_order_idc indicates the output order of samples resulting from the post-processing filter.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose is equal to 2 or 4, nnpfc_out_order_idc shall not be equal to 3.

Table 2-3 contains an informative description of nnpfc_out_order_idc values.

TABLE 2-3
Description of nnpfc_out_order_idc values

| nnpfc_out_order_idc | Description |
|---|---|
| 0 | Only the luma matrix is present in the output |
| | tensor, thus the number of channels is 1. |
| 1 | Only the chroma matrices are present in the |
| | output tensor, thus the number of channels is 2. |
| 2 | The luma and chroma matrices are present in the |
| | output tensor, thus the number of channels is 3. |
| 3 | Four luma matrices and two chroma matrices are |
| | present in the output tensor, thus the number |
| | of channels is 6. This nnpfc_out_order_idc can |
| | only be used when the chroma format is 4:2:0. |
| 4 . . . 255 | Reserved |

The process StoreOutputTensors( ), for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < numInputPics; i++ ) {
  if( nnpfc_out_order_idc = = 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfc_pic_height_in_luma_samples && xY < nnpfc_pic_width_in_luma_samples )
          if( !nnpfc_component_last_flag )
            FilteredYPic[ i ][ xY ][yY ] = outputTensor[ 0 ][ i ][ 0 ][ yP ][ xP ]
          else
            FilteredYPic[ i ][ xY ][ yY ] = outputTensor[ 0 ][ i ][ yP ][ xP ][ 0 ]
      }
```

| | |
|---|---|
| else if( nnpfc_out_order_idc = = 1 ) | (83) |

```
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfc_pic_height_in_luma_samples / outSubHeightC &&
            xSrc < nnpfc_pic_width_in_luma_samples / outSub WidthC )
          if( !nnpfc_component_last_flag ) {
            FilteredCbPic[ i ][ xSrc ][ ySrc ] = outputTensor[ 0 ][ i ][ 0 ][ yP ][ xP ]
            FilteredCrPic[ i ][ xSrc ][ ySrc ] = output Tensor[ 0 ][ i ][ 1 ][ yP ][ xP ]
          } else {
            FilteredCbPic[ i ][ xSrc ][ ySrc ] = outputTensor[ 0 ][ i ][ yP ][ xP ][ 0 ]
            FilteredCrPic[ i ][ xSrc ][ ySrc ] = outputTensor[ 0 ][ i ][ yP ][ xP ][ 1 ]
          }
      }
  else if( nnpfc_out_order_idc = = 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = ( yP / outSubHeightC ) * outSubHeightC
        xPc = ( xP / outSubWidthC ) * outSubWidthC
        if ( yY < nnpfc_pic_height_in_luma_samples && xY < nnpfc_pic_width_in_luma_samples)
          if( !nnpfc_component_last_flag ) {
            FilteredYPic[ i ][ xY ][ yY ] = outputTensor[ 0 ][ i ][ 0 ][ yP ][ xP ]
            FilteredCbPic[ i ][ xC ][ yC ] = outputTensor[ 0 ][ i ][ 1 ][ yPc ][ xPc ]
            FilteredCrPic[ i ][ xC ][ yC ] = outputTensor[ 0 ][ i ][ 2 ][ yPc ][ xPc ]
          } else {
            FilteredYPic[ i ][ xY ][ yY ] = outputTensor[ 0 ][ i ][ yP ][ xP ][ 0 ]
            FilteredCbPic[ i ][ xC ][ yC ] = outputTensor[ 0 ][ i ][ yPc ][ xPc ][ 1 ]
            FilteredCrPic[ i ][ xC ][ yC ] = outputTensor[ 0 ][ i ][ yPc ][ xPc ][ 2 ]
          }
      }
  else if( nnpfc_out_order_idc = = 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfc_pic_height_in_luma_samples / 2 &&
            xSrc < nnpfc_pic_width_in_luma_samples / 2 )
          if( !nnpfc_component_last_flag ) {
            FilteredYPic[ i ][ xSrc * 2 ][ ySrc * 2 ] = outputTensor[ 0 ][ i ][ 0 ][ yP ][ xP ]
            FilteredYPic[ i ][ xSrc * 2 + 1 ][ ySrc * 2 ] = outputTensor[ 0 ][ i ][ 1 ][ yP ][ xP ]
            FilteredYPic[ i ][ xSrc * 2 ][ ySrc * 2 + 1 ] = outputTensor[ 0 ][ i ][ 2 ][ yP ][ xP ]
            FilteredYPic[ i ][ xSrc * 2 + 1][ ySrc * 2 + 1 ] = outputTensor[ 0 ][ i ][ 3 ][ yP ][ xP ]
            FilteredCbPic[ i ][ xSrc ][ ySrc ] = outputTensor[ 0 ][ i ][ 4 ][ yP ][ xP ]
            FilteredCrPic[ i ][ xSrc ][ ySrc ] = outputTensor[ 0 ][ i ][ 5 ][ yP ][ xP ]
          } else {
            FilteredYPic[ i ][ xSrc * 2 ][ ySrc * 2 ] = outputTensor[ 0 ][ i ][ yP ][ xP ][ 0 ]
            FilteredYPic[ i ][ xSrc * 2 + 1 ][ ySrc * 2 ] = outputTensor[ 0 ][ i ][ yP ][ xP ][ 1 ]
            FilteredYPic[ i ][ xSrc * 2 ][ ySrc * 2 + 1 ] = outputTensor[ 0 ][ i ][ yP ][ xP ][ 2 ]
            FilteredYPic[ i ][ xSrc * 2 + 1][ ySrc * 2 + 1 ] = outputTensor[ 0 ][ i ][ yP ][ xP ][ 3 ]
            FilteredCbPic[ i ][ xSrc ][ ySrc ] = outputTensor[ 0 ][ i ][ yP ][ xP ][ 4 ]
            FilteredCrPic[ i ][ xSrc ][ ySrc ] = outputTensor[ 0 ][ i ][ yP ][ xP ][ 5]
          }
      }
}.
```

nnpfc_constant_patch_size_flag equal to 1 indicates that the post-processing filter accepts exactly the patch size indicated by nnpfc_patch_width_minus1 and nnpfc_patch_height_minus1 as input. nnpfc_constant_patch_size_flag equal to 0 indicates that the post-processing filter accepts any patch size that is a positive integer multiple of the patch size indicated by nnpfc_patch_width_minus1 and nnpfc_patch_height_minus1 as input.

nnpfc_patch_width_minus1+1, when nnpfc_constant_patch_size_flag equal to 1, indicates the horizontal sample counts of the patch size required for the input to the post-processing filter. The value of nnpfc_patch_width_minus1 shall be in the range of 0 to Min(32766, CroppedWidth−1), inclusive.

nnpfc_patch_height_minus1+1, when nnpfc_constant_patch_size_flag equal to 1, indicates the vertical sample counts of the patch size required for the input to the post-processing filter. The value of nnpfc_patch_height_minus1 shall be in the range of 0 to Min(32766, CroppedHeight−1), inclusive.

Let the variables inpPatchWidth and inpPatchHeight be the patch size width and the patch size height, respectively.

If nnpfc_constant_patch_size_flag is equal to 0, the following applies:
The values of inpPatchWidth and inpPatchHeight are either provided by external means not specified in this document or set by the post-processor itself.
The value of inpPatchWidth shall be a positive integer multiple of nnpfc_patch_width_minus1+1 and shall be less than or equal to CroppedWidth. The value of inpPatchHeight shall be a positive integer multiple of nnpfc_patch_height_minus1+1 and shall be less than or equal to CroppedHeight.

Otherwise (nnpfc_constant_patch_size_flag is equal to 1), the value of inpPatchWidth is set equal to nnpfc_patch_width_minus1+1 and the value of inpPatchHeight is set equal to nnpfc_patch_height_minus1+1. nnpfc_overlap indicates the overlapping horizontal and vertical sample counts of adjacent input tensors of the post-processing filter. The value of nnpfc_overlap shall be in the range of 0 to 16383, inclusive.

The variables outPatchWidth, outPatchHeight, horCScaling, verCScaling, outPatchCWidth, outPatchCHeight, and overlapSize are derived as follows:

$$outPatchWidth = ( nnpfc\_pic \_width \_in \_luma \_samples * inpPatchWidth ) / CroppedWidth \qquad ( 84 )$$

$$outPatchHeight = \text{} ( nnpfc\_pic \text{} \_height \text{} \_in \text{} \_luma \text{} \_samples * inpPatchHeight ) \text{} / CroppedHeight \qquad ( 85 )$$

$$horCScaling = SubWidthC / outSubWidthC \qquad ( 86 )$$

$$verCScaling = SubHeightC / outSubHeightC \qquad ( 87 )$$

$$outPatchCWidth = outPatchWidth * horCScaling \qquad ( 88 )$$

$$outPatchCHeight = outPatchHeight * verCScaling \qquad ( 89 )$$

$$overlapSize = nnpfc\_overlap . \qquad ( 90 )$$

It is a requirement of bitstream conformance that outPatchWidth*CroppedWidth shall be equal to nnpfc_pic_width_in_luma_samples*inpPatchWidth and outPatchHeight*CroppedHeight shall be equal to nnpfc_pic_height_in_luma_samples*inpPatchHeight.

nnpfc_padding_type indicates the process of padding when referencing sample locations outside the boundaries of the cropped decoded output picture as described in Table 2-4. The value of nnpfc_padding_type shall be in the range of 0 to 15, inclusive.

TABLE 2-4
Informative description of nnpfc_padding_type values

| nnpfc_padding_type | Description |
|---|---|
| 0 | zero padding |
| 1 | replication padding |
| 2 | reflection padding |
| 3 | wrap-around padding |
| 4 | fixed padding |
| 5 . . . 15 | Reserved |

nnpfc_luma_padding_val indicates the luma value to be used for padding when nnpfc_padding_type is equal to 4.

nnpfc_cb_padding_val indicates the Cb value to be used for padding when nnpfc_padding_type is equal to 4.

nnpfc_cr_padding_val indicates the Cr value to be used for padding when nnpfc_padding_type is equal to 4.

The function InpSampleVal(y, x, picHeight, picWidth, croppedPic) with inputs being a vertical sample location y, a horizontal sample location x, a picture height picHeight, a picture width picWidth, and sample array croppedPic returns the value of sampleVal derived as follows:
NOTE 6—For the inputs to the function InpSampleVal( ), the vertical location is listed before the horizontal location for compatibility with input tensor conventions of some inference engines.

```
if( nnpfc_padding_type = = 0 )
  if( y < 0 | | x < 0 | | y >= picHeight | | x >= picWidth )
    sampleVal = 0
  else
```

| | |
|---|---|
| sampleVal = croppedPic[ x ][ y ] | (91) |

```
else if( nnpfc_padding_type = = 1 )
  sampleVal = croppedPic[ Clip3( 0, picWidth − 1, x ) ][ Clip3( 0, picHeight − 1, y ) ]
else if( nnpfc_padding_type = = 2 )
  sampleVal = croppedPic[ Reflect( picWidth − 1, x ) ][ Reflect( picHeight − 1, y ) ]
else if( nnpfc_padding_type = = 3 )
  if( y >=0 && y < picHeight )
    sampleVal = croppedPic[ Wrap( picWidth − 1, x ) ][ y ]
else if( nnpfc_padding_type = = 4 )
  if( y < 0 | | x < 0 | | y >= picHeight | | x >= picWidth )
    sampleVal[ 0 ] = nnpfc_luma_padding_val
      sampleVal[ 1 ] = nnpfc_cb_padding_val
    sampleVal[ 2 ] = nnpfc_cr_padding_val
  else
    sampleVal = croppedPic[ x ][ y ].
```

The following example process may be used to filter the cropped decoded output picture patch-wise with the post-processing filter PostProcessingFilter( ) to generate the filtered picture, which contains Y, Cb, and Cr sample arrays FilteredYPic, FilteredCbPic, and FilteredCrPic, respectively, as indicated by nnpfc_out_order_idc.

```
if( nnpfc_inp_order_idc = = 0 )
  for( cTop = 0; cTop < CroppedHeight; cTop += inpPatchHeight )
    for( cLeft = 0; cLeft < CroppedWidth; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 1 )
  for( cTop = 0; cTop < CroppedHeight / SubHeightC; cTop += inpPatchHeight )
    for( cLeft = 0; cLeft < CroppedWidth / SubWidthC; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 2 )
```

| | |
|---|---|
| for( cTop = 0; cTop < CroppedHeight; cTop += inpPatchHeight) | (92) |

```
    for( cLeft = 0; cLeft < CroppedWidth; cLeft += inpPatchWidth) {
      DeriveInputTensors( )
      outputTensor = PostProcessingFilter( inputTensor )
      StoreOutputTensors( )
    }
else if( nnpfc_inp_order_idc = = 3 )
  for( cTop = 0; cTop < CroppedHeight; cTop += inpPatchHeight * 2 )
    for( cLeft = 0; cLeft < CroppedWidth; cLeft += inpPatchWidth * 2 ) {
      DeriveInputTensors( )
      outputTensor = PostProcessingFilter( inputTensor )
      StoreOutputTensors( )
    }.
```

nnpfc_complexity_info_present_flag equal to 1 specifies that one or more syntax elements that indicate the complexity of the post-processing filter associated with the nnpfc_id are present. nnpfc_complexity_info_present_flag equal to 0 specifies that no syntax elements that indicates the complexity of the post-processing filter associated with the nnpfc_id are present.

nnpfc_parameter_type_idc equal to 0 indicates that the neural network uses only integer parameters. nnpfc_parameter_type_flag equal to 1 indicates that the neural network may use floating point or integer parameters. nnpfc_parameter_type_idc equal to 2 indicates that the neural network uses only binary parameters. nnpfc_parameter_type_idc equal to 3 is reserved for future use by ITU-T|ISO/IEC and shall not be present in bitstreams conforming to this edition of this document. Decoders conforming to this edition of this document shall ignore NNPFC SEI messages with nnpfc_parameter_type_idc equal to 3.

nnpfc_log 2_parameter_bit_length_minus3 equal to 0, 1, 2, and 3 indicates that the neural network does not use parameters of bit length greater than 8, 16, 32, and 64, respectively. When nnpfc_parameter_type_idc is present and nnpfc_log 2_parameter_bit_length_minus3 is not present the neural network does not use parameters of bit length greater than 1.

nnpfc_num_parameters_idc indicates the maximum number of neural network parameters for the post processing filter in units of a power of 2048. nnpfc_num_parameters_idc equal to 0 indicates that the maximum number of neural network parameters is unknown. The value nnpfc_num_parameters_idc shall be in the range of 0 to 52, inclusive. Values of nnpfc_num_parameters_idc greater than 52 are reserved for future use by ITU-T|ISO/JEC and shall not be present in bitstreams conforming to this edition of this document. Decoders conforming to this edition of this document shall ignore NNPFC SEI messages with nnpfc_num_parameters_idc greater than 52.

If the value of nnpfc_num_parameters_idc is greater than zero, the variable maxNumParameters is derived as follows:

$$maxNumParameters = ( 2048 ≪ nnpfc\_num \_parameters \_idc ) - 1. \qquad ( 93 )$$

It is a requirement of bitstream conformance that the number of neural network parameters of the post-processing filter shall be less than or equal to maxNumParameters.

nnpfc_num_kmac_operations_idc greater than 0 indicates that the maximum number of multiply-accumulate operations per sample of the post-processing filter is less than or equal to nnpfc_num_kmac_operations_idc*1000. nnpfc_num_kmac_operations_idc equal to 0 indicates that the maximum number of multiply-accumulate operations of the network is unknown. The value of nnpfc_num_kmac_operations_idc shall be in the range of 0 to 232-1, inclusive.

nnpfc_total_kilobyte_size greater than 0 indicates a total size in kilobytes required to store the uncompressed parameters for the neural network. The total size in bits is a number equal to or greater than the sum of bits used to store each parameter. nnpfc_total_kilobyte_size is the total size in bits divided by 8000, rounded up. nnpfc_total_kilobyte_size equal to 0 indicates that the total size required to store the parameters for the neural network is unknown. The value of nnpfc_total_kilobyte_size shall be in the range of 0 to 232-1, inclusive.

nnpfc_reserved_zero_bit_b shall be equal to 0 in bitstreams conforming to this edition of this document. Decoders shall ignore NNPFC SEI messages in which nnpfc_reserved_zero_bit_b is not equal to 0.

nnpfc_payload_byte[i] contains the i-th byte of a bitstream conforming to ISO/JEC 15938-17. The byte sequence nnpfc_payload_byte[i] for all present values of i shall be a complete bitstream that conforms to ISO/JEC 15938-17.

### 8.29 Neural-Network Post-Filter Activation SEI Message

### 8.29.1 Neural-Network Post-Filter Activation SEI Message Syntax

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) { | |
| nnpfa_persistence_flag | u(1) |
| } | |

### 8.29.2 Neural-Network Post-Filter Activation SEI Message Semantics

The neural-network post-filter activation (NNPFA) SEI message activates or de-activates the possible use of the target neural-network post-processing filter, identified by nnpfa_target_id, for post-processing filtering of a set of pictures.
NOTE 1—There can be several NNPFA SEI messages present for the same picture, for example, when the post-processing filters are meant for different purposes or filter different colour components.

nnpfa_target_id indicates the target neural-network post-processing filter, which is specified by one or more neural-network post-processing filter characteristics SEI messages that pertain to the current picture and have nnpfc_id equal to nnfpa_target_id.

The value of nnpfa_target_id shall be in the range of 0 to 232-2, inclusive. Values of nnpfa_target_id from 256 to 511, inclusive, and from 231 to 232-2, inclusive, are reserved for future use by ITU-T|ISO/JEC. Decoders conforming to this edition of this document encountering an NNPFA SEI message with nnpfa_target_id in the range of 256 to 511, inclusive, or in the range of 231 to 232-2, inclusive, shall ignore the SEI message.

An NNPFA SEI message with a particular value of nnpfa_target_id shall not be present in a current PU unless one or both of the following conditions are true:
Within the current CLVS there is an NNPFC SEI message with nnpfc_id equal to the particular value of nnpfa_target_id present in a PU preceding the current PU in decoding order.
There is an NNPFC SEI message with nnpfc_id equal to the particular value of nnpfa_target_id in the current PU.

When a PU contains both an NNPFC SEI message with a particular value of nnpfc_id and an NNPFA SEI message with nnpfa_target_id equal to the particular value of nnpfc_id, the NNPFC SEI message shall precede the NNPFA SEI message in decoding order.

nnpfa_cancel_flag equal to 1 indicates that the persistence of the target neural-network post-processing filter established by any previous NNPFA SEI message with the same nnpfa_target_id as the current SEI message is cancelled, i.e., the target neural-network post-processing filter is no longer used unless it is activated by another NNPFA SEI message with the same nnpfa_target_id as the current SEI message and nnpfa_cancel_flag equal to 0. nnpfa_cancel_flag equal to 0 indicates that the nnpfa_persistence_flag follows.

nnpfa_persistence_flag specifies the persistence of the target neural-network post-processing filter for the current layer.

nnpfa_persistence_flag equal to 0 specifies that the target neural-network post-processing filter may be used for post-processing filtering for the current picture only.

nnpfa_persistence_flag equal to 1 specifies that the target neural-network post-processing filter may be used for post-processing filtering for the current picture and all subsequent pictures of the current layer in output order until one or more of the following conditions are true:
A new CLVS of the current layer begins.
The bitstream ends.
A picture in the current layer associated with a NNPFA SEI message with the same nnpfa_target_id as the current SEI message and nnpfa_cancel_flag equal to 1 is output that follows the current picture in output order.
NOTE 2—The target neural-network post-processing filter is not applied for this subsequent picture in the current layer associated with a NNPFA SEI message with the same nnpfa_target_id as the current SEI message and nnpfa_cancel_flag equal to 1.

### 4. Problems

The current design for the neural-network post-filter characteristics (NNPFC) and the neural-network post-filter activation (NNPFA) SEI message has the following problems:
1) The NNPFC/NNPFA SEI message specifies that sample arrays of a cropped decoded output picture are used as one of the input pictures to the post-processing filter. However, which decoded pictures should be utilized as the input pictures for post-processing filter are NOT specified when the post-processing filter is applied for current picture.
2) The NNPFC/NNPFA SEI message specifies that the post-processing filter may employ the decoded information such as reconstructed samples of decoded pictures as the input. However, the input pictures used for post-processing filter may be removed by the decoded picture buffer (DPB). The availability of input pictures should be specified.
3) The NNPFC/NNPFA SEI message specifies that there may be multiple input pictures and multiple output pictures for post-processing filter, such as for the case of picture rate upsampling. However, the storage of multiple input and output pictures for post-processing filter is not limited.
4) The NNPFC/NNPFA SEI message specifies how to filter the samples with purpose of picture rate upsampling. However, the overlap and gap of pictures between multiple filtering processes with post-processing filters are not specified.

### 5. Detailed Solutions

To solve the above problems, methods as summarized below are disclosed. The embodiments should be considered as examples to explain the general concepts and should not be interpreted in a narrow way. Furthermore, these embodiments can be applied individually or combined in any manner.
1) To solve problem 1, whether input picture of post-processing filter is the current picture may be specified.
   a. In one example, a constraint may be specified that the input picture of post-processing filter is the current picture.
      i. In one example, the input picture of post-processing filter may be the current picture when only one input picture of post-processing filter is supported.
   b. In one example, a syntax element nnpfa_input_is_curr in NNPFA/NNPFC may be signalled to indicated that whether the current picture is the only input picture.
   c. In one example, a syntax element nnpfa_input_contain_curr in NNPFA/NNPFC may be signalled to indicated that whether the input pictures include the current picture.
   d. In one example, at least the current picture is employed as one of the input pictures of post-processing filter.
   e. In one example, the purpose may be resolution upsampling and/or picture rate upsampling and/or chroma upsampling and/or visual quality improvement.
   f. The term “picture” may be replaced by “slice”, “sub-picture”, “tile”, etc.
2) To solve problem 1, the input pictures may be defined or constrained according to certain conditions or adaptive conditions when there are one or multiple input pictures employed for post-processing filter.
   a. In one example, the input pictures may be defined or constrained according to temporal layer(s).
      i. In one example, the input pictures with same and/or lower and/or higher temporal level compared with current picture may be used for post-processing filter.
      ii. In one example, the input pictures with same and/or lower and/or higher temporal level compared with current picture cannot be used for post-processing filter.
   b. In one example, the input pictures may be defined or constrained according to QP(s).
      i. In one example, the input pictures with same and/or lower and/or higher QP with current picture are used for post-processing filter.
      ii. In one example, the input pictures with same and/or lower and/or higher QP with current picture cannot be used for post-processing filter.
   c. In one example, the input pictures with a specific slice type with current picture are used for post-processing filter.
   d. In one example, the input pictures with a specific slice type with current picture cannot be used for post-processing filter.
   e. In one example, the purpose of NNPF may include but is not limited to resolution upsampling and/or picture rate upsampling and/or chroma upsampling and/or visual quality improvement and/or bitdepth increase.
3) To solve problem 2, whether input pictures to be used for post-processing filter should be available in the DPB may be specified.
   a. In one example, a syntax element nnpfc_pic_in_dbp in NNPFA/NNPFC may be signalled to indicate whether all input pictures must be available in the DPB.
   b. In one example, a constraint may be specified that all input pictures to be used for post-processing filter must be available in the DPB.
   c. In one example, the input pictures may be NOT used for post-processing filter when input pictures are NOT available in the DPB.
4) To solve problem 2, whether input pictures to be used for post-processing filter should be reference pictures of the current picture (or the current picture itself) may be specified.
   a. In one example, a syntax element nnpfc_pic_in_reflist in NNPFA/NNPFC may be signalled to indicate whether all input pictures must be reference pictures (or the current picture itself).
   b. In one example, a constraint may be specified that all input pictures to be used for post-processing filter must be reference pictures of the current picture (or the current picture itself).
   c. In one example, the input pictures may be NOT used for post-processing filter when input pictures are NOT reference pictures of the current picture (or the current picture itself).
5) To solve problem 3, the maximum picture buffer size needed for the storage of the input and output pictures of the NNPF may be specified.
   a. In one example, the maximum picture buffer size Bᵢₙₚᵤₜ needed for the storage of the input pictures of the NNPF and the maximum picture buffer size Bₒᵤₜₚᵤₜ needed for the storage of the output pictures of the NNPF may be specified, respectively.
      i. In one example, a constraint may be specified that the Bᵢₙₚᵤₜ and/or Bₒᵤₜₚᵤₜ is smaller than or equal to DPB size B_{dbp} in image/video bitstream.
      ii. In one example, a constraint may be specified that the sum value of Bᵢₙₚᵤₜ and Bₒᵤₚᵤₜ is smaller than or equal to DPB size B_{dbp} in image/video bitstream.
      iii. In one example, a syntax element nnpfa_max_input_pic_buffer in NNPFA/NNPFC may be signalled to indicate Bᵢₙₚᵤₜ.
      iv. In one example, a syntax element nnpfa_max_output_pic_buffer in NNPFA/NNPFC may be signalled to indicate Bₒᵤₜₚᵤₜ.
      v. In one example, a syntax element nnpfa_max_input_pic_buffer_diff may be signalled to indicate difference between Bᵢₙₚᵤₜ and B_{dbp}.
      vi. In one example, a syntax element nnpfa_max_output_pic_buffer_diff may be signalled to indicate difference between Bₒᵤₜₚᵤₜ and B_{dbp}.
   b. In one example, the maximum picture buffer sizes Borat may define the total storage of the input pictures and output pictures of the NNPF.
      i. In one example, a constraint may be specified that the Bₜₒₜₐₗ is smaller than or equal to DPB size B_{dbp} in image/video bitstream.
      ii. In one example, a syntax element nnpfa_max_all_pic_buffer may be signalled to indicate Bₜₒₜₐₗ.
      iii. In one example, a syntax element nnpfa_max_all_pic_buffer_diff may be signalled to indicate difference between Bₜₒₜₐₗ and B_{dbp}.
6) To solve problem 4, the mechanism of upsampling the picture rate may be specified.
   a. In one example, one or multiple sliding window mechanisms may be employed for post-processing filter.
      i. In one example, a syntax element may be signalled to indicate that whether the sliding window mechanism is used.
   b. In one example, a syntax element may be signalled to indicate that whether there are overlapped pictures between multiple filtering process with post-processing filters.
      i. In one example, a syntax element may be signalled to indicate the overlapping amount of pictures when there are one or multiple overlapped pictures between multiple filtering process with post-processing filters.
   c. In one example, a syntax element may be signalled to indicate that whether there are gaps between multiple filtering process with post-processing filters.
      i. In one example, a syntax element may be signalled to indicate the gap size of pictures when there are gaps between multiple filtering process with post-processing filters.
7) In one example, a picture which is not the current picture to be input to the post-processing filter may be indicted by POC or POC distance, which is determined by the displaying order.
8) In one example, a picture which is not the current picture to be input to the post-processing filter may be indicted by decoding order index (DOI) or DOI distance, which is determined by the decoding order.
9) In one example, a picture which is not the current picture to be input to the post-processing filter may be indicted by reference index and/or reference list.
10) Methods disclosed in the document may also be applied to post-processing filters other than NN-based post-processing filtering.
11) Methods disclosed in the document may also be applied to in-loop filtering, which is NN-based or non-NN-based.

### 6. Embodiments

Below are some example embodiments for the present disclosure aspects summarized above in Section 5.

Most relevant parts that have been added or modified are shown in using bolded words (e.g., this format indicates added text), and some of the deleted parts are shown by using words in italics between double curly brackets (e.g., {{this format indicates deleted text}}). There may be some other changes that are editorial in nature and thus not highlighted. It should be understood that only markings in this section are intended to represent changes.

### 6.1. Embodiment 1

This embodiment is for present disclosure item 1 and all its subitems summarized above in Section 5.

### 8.28.2 Neural-Network Post-Filter Characteristics SEI Message Semantics

The neural-network post-filter characteristics (NNPFC) SEI message specifies a neural network that may be used as a post-processing filter. The use of specified post-processing filters for specific pictures is indicated with neural-network post-filter activation SEI messages.

Use of this SEI message requires the definition of the following variables:
Cropped decoded output picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the cropped decoded output pictures with idx in the range of 0 to numInputPics−1, inclusive, that are used as input for the post-processing filter.
Bit depth BitDepthY for the luma sample array of the cropped decoded output pictures.
Bit depth BitDepthC for the chroma sample arrays, if any, of the cropped decoded output pictures.
A chroma format indicator, denoted herein by ChromaFormatIdc, as described in subclause 7.3.
When nnpfc_auxiliary_inp_idc is equal to 1, a filtering strength control value StrengthControlVal that shall be a real number in the range of 0 to 1, inclusive.
NOTE 1—When only one decoded output picture is used as input for the post-processing filter, the decoded output picture is current picture.

The variables SubWidthC and SubHeightC are derived from ChromaFormatIdc as specified by Table 2.
NOTE 1—More than one NNPFC SEI message can be present for the same picture. When more than one NNPFC SEI message with different values of nnpfc_id is present or activated for the same picture, they can have the same or different values of nnpfc_purpose and nnpfc_mode_idc.

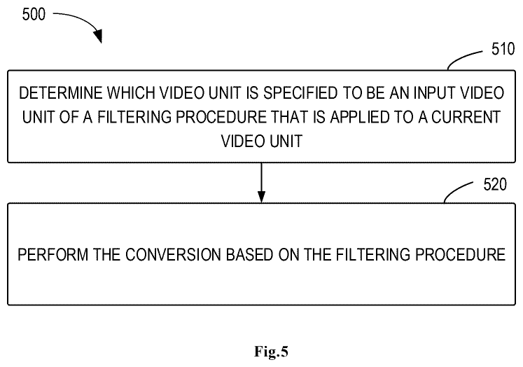

FIG. 5 illustrates a flowchart of a method 500 for video processing in accordance with embodiments of the present disclosure. The method 500 is implemented during a conversion between a video unit of a video and a bitstream of the video.

At block 510, for a conversion between a video unit of a video and a bitstream of the video, it is determined which video unit is specified to be an input video unit of a filtering procedure that is applied to a current video unit. In some embodiments, the filtering procedure may comprises one of: a post-processing filtering procedure, a neural network (NN)-based post processing filtering procedure, an NN-based in-loop filtering procedure, or a non-NN-based in-loop filtering procedure.

At block 520, the conversion is performed based on the filtering procedure. In some embodiments, the conversion may include encoding the video unit from the bitstream. Alternatively, or in addition, the conversion may include decoding the video unit from the bitstream. In this way, it can improve coding efficiency and coding performance.

In some embodiments, the video unit may comprises one of: a picture, a slice, a sub-picture, or a tile. In some embodiments, the input video unit may comprises one of: an input picture, an input slice, an input sub-picture, or an input tile. In some embodiments, the current video unit may comprises one of: a current picture, a current slice, a current sub-picture, or a current tile.

In some embodiments, the current video unit may be specified to be the input video unit of the filter. For example, if only one input video unit of the post-processing filter is supported, the current video unit can be the input video unit of the filter.

In some embodiments, a neural-network post-filter (NNPF) activation (NNPFA) supplemental enhancement information (SEI) message or a NNPF characteristics (NNPFC) SEI message may comprises a syntax element indicating whether the current video unit is the only input video unit and the input video unit comprises the current video unit. For example, the syntax element may be an NNPFA input is the current picture (nnpfa_input_is_curr) syntax element.

In some embodiments, at least the current video unit is employed as one of input video units of the filter. For example, the input video units of the filtering procedure may be defined according to a condition based on whether there is one or more input video units employed for the filtering procedure.

In some embodiments, the input video units may be defined according to temporal layers.

In some embodiments, input video units with same temporal level with the current video unit may be used for the filtering procedure. Alternatively, or in addition input video units with lower temporal level than the current video unit may be used for the filtering procedure. Alternatively, or in addition, input video units with higher temporal level than the current video unit may be used for the filtering procedure.

In some embodiments, input video units with same temporal level with the current video unit may be not used for the filtering procedure. Alternatively, or in addition, input video units with lower temporal level than the current video unit may be not used for the filtering procedure. Alternatively, or in addition, input video units with higher temporal level than the current video unit may be not used for the filtering procedure.

In some embodiments, the input video units may be defined according to quantization parameters (QPs). For example, input video units with same QP with the current video unit may be used for the filtering procedure. Alternatively, or in addition, input video units with lower QP than the current video unit may be used for the filtering procedure. Alternatively, in addition, input video units with higher QP than the current video unit may be used for the filtering procedure.

In some embodiments, input video units with same QP with the current video unit may be not used for the filtering procedure. Alternatively, or in addition, input video units with lower QP than the current video unit may be not used for the filtering procedure. Alternatively, or in addition, input video units with higher QP than the current video unit may be not used for the filtering procedure. Input video units with a target slice type with current video unit may be used for the filtering procedure. Alternatively, input video units with a target slice type with current video unit may not be used for the filtering procedure.

In some embodiments, a purpose of the filtering procedure comprises at least one of: resolution upsampling, picture rate upsampling, chroma upsampling, visual quality improvement, or bitdepth increase. Whether input video units to be used for the filtering procedure are available in a decoded picture buffer (DPB) may be specified.

In some embodiments, a NNPFA SEI message or a NNPFC SEI message may comprises a syntax element indicating whether all input video units used for the filtering procedure are available in the DPB. In some embodiments, the syntax x element can be an NNPFC picture in decoding picture buffer (nnpfc_pic_in_dbp) syntax element. All input video units may be used for the filtering procedure can be available in a DPB. If the input video units are not available in a DPB, the input video units may be not used for the filtering procedure. In some embodiments, whether input video units to be used for the filtering procedure are reference pictures of the current video may be specified.

In some embodiments, a NNPFA SEI message or a NNPFC SEI message may comprises a syntax element indicating whether all input video units are refence video units or the current video unit. By way of example, the syntax element may be an NNPFC picture in reference picture list (nnpfc_pic_in_reflist) syntax element. All input video units used for the filtering procedure can be reference video units of the current video unit or the current video unit. In some embodiments, if the input video units are not reference video units of the current video unit or the current video unit, the input video units may be not used for the filtering procedure.

In some embodiments, a maximum picture buffer size needed for a storage of input and output video units of the filtering procedure may be specified. A first maximum picture buffer size for the storage of the input video units of the filtering procedure may be specified, and a second maximum picture buffer size for the storage of the output video units of the filtering procedure may be specified. In some embodiments, at least one of: the first maximum picture buffer size or the second maximum picture buffer size may be smaller than or equal to a DPB size in the bitstream. In some other embodiments, a sum value of the first maximum picture buffer size and the second maximum picture buffer size may be smaller than or equal to a DPB size in the bitstream.

In some embodiments, a NNPFA SEI message or a NNPFC SEI message may comprises at least one of: a first syntax element indicating the first maximum picture buffer size for the storage of the input video units of the filtering procedure, a second syntax element indicating the second maximum picture buffer size for the storage of the output video units of the filtering procedure, a third syntax element indicating a difference between the first maximum picture buffer size and the DPB size, or a fourth syntax element indicating a difference between the second maximum picture buffer size and the DPB size.

In some embodiments, the first syntax element is an NNPFA maximum input picture buffer (nnpfa_max_input_pic_buffer) syntax element. Alternatively, or in addition, the second syntax element is an NNPFA maximum output picture buffer (nnpfa_max_output_pic_buffer) syntax element. Alternatively, or in addition, the third syntax element is an NNPFA maximum input picture buffer difference (nnpfa_max_input_pic_buffer_diff) syntax element. Alternatively, or in addition, the fourth syntax element is an NNPFA maximum output picture buffer difference (nnpfa_max_output_pic_buffer_diff) syntax element.

In some embodiments, a maximum picture buffer size may define a total storage of the input video units and output video units of the filtering procedure. The maximum picture buffer size may be smaller than or equal to a DPB size. By way of example, a syntax element may indicate the maximum picture buffer size or a difference between the maximum picture buffer size and a DPB size.

In some embodiments, a mechanism of upsampling a picture rate is specified. One or more sliding window mechanisms may be employed for the filtering procedure. By way of example, a syntax element may be signalled to indicate that whether the sliding window mechanism is used. In some embodiments, a syntax element may be signalled to indicate whether there are overlapped video units between a plurality of filtering processes with post-processing filters. For example, a syntax element may be signalled to indicate the number of overlapped of video units if there are one or more overlapped video units between the plurality of filtering processes with post-processing filters.

In some other example embodiments, a syntax element may be signaled to indicate whether there are gaps between a plurality of filtering processes with post-processing filters. For example, a syntax element may be signaled to indicate a gap size of video units if there are gaps between the plurality of filtering processes with post-processing filters.

In some embodiments, a video unit which is not the current video unit to be input to the filtering procedure may be indicted by a picture order count (POC) or a POC distance. The POC or the POC distance may be determined by a displaying order. A video unit which is not the current video unit to be input to the filtering procedure may be indicted by decoding order index (DOI) or DOI distance. The DOI or the DOI distance may be determined by a decoding order.

In some embodiments, a video unit which is not the current video unit to be input to the filtering procedure may be indicated by at least one of: a reference index or a reference list.

According to further embodiments of the present disclosure, a non-transitory computer-readable recording medium is provided. The non-transitory computer-readable recording medium stores a bitstream of a video which is generated by a method performed by an apparatus for video processing. The method comprises: determining which video unit is specified to be an input video unit of a filtering procedure that is applied to a current video unit of the video; and generating the bitstream based on the filtering procedure.

According to still further embodiments of the present disclosure, a method for storing bitstream of a video is provided. The method comprises: determining which video unit is specified to be an input video unit of a filtering procedure that is applied to a current video unit of the video; generating the bitstream based on the filtering procedure; and storing the bitstream in a non-transitory computer-readable medium.

Implementations of the present disclosure can be described in view of the following clauses, the features of which can be combined in any reasonable manner.

Clause 1. A method for video processing, comprising: determining, for a conversion between a video unit of a video and a bitstream of the video, which video unit is specified to be an input video unit of a filtering procedure that is applied to a current video unit; and performing the conversion based on the filtering procedure.

Clause 2. The method of clause 1, where the filtering procedure comprises one of: a post-processing filtering procedure, a neural network (NN)-based post processing filtering procedure, an NN-based in-loop filtering procedure, or a non-NN-based in-loop filtering procedure.

Clause 3. The method of clause 1 or 2, where the video unit comprises one of: a picture, a slice, a sub-picture, or a tile, where the input video unit comprises one of: an input picture, an input slice, an input sub-picture, or an input tile. and where the current video unit comprises one of: a current picture, a current slice, a current sub-picture, or a current tile.

Clause 4. The method of any of clauses 1-3, where the current video unit is specified to be the input video unit of the filter.

Clause 5. The method of clause 4, where the current video unit is the input video unit of the filter, if only one input video unit of the post-processing filter is supported.

Clause 6. The method of any of clauses 1-3, where a neural-network post-filter (NNPF) activation (NNPFA) supplemental enhancement information (SEI) message or a NNPF characteristics (NNPFC) SEI message comprises a syntax element indicating whether the current video unit is the only input video unit.

Clause 7. The method of any of clauses 1-3, where a NNPFA SEI message or a NNPFC SEI message comprises a syntax element indicating whether the input video unit comprises the current video unit.

Clause 8. The method of clause 6 or 7, where the syntax element is an NNPFA input is the current picture (nnpfa_input_is_curr) syntax x element.

Clause 9. The method of any of clauses 1-3, where at least the current video unit is employed as one of input video units of the filter.

Clause 10. The method of any of clauses 1-3, where input video units of the filtering procedure are defined according to a condition based on whether there is one or more input video units employed for the filtering procedure.

Clause 11. The method of clause 10, where the input video units are defined according to temporal layers.

Clause 12. The method of clause 11, where input video units with same temporal level with the current video unit are used for the filtering procedure, and/or where input video units with lower temporal level than the current video unit are used for the filtering procedure, and/or where input video units with higher temporal level than the current video unit are used for the filtering procedure.

Clause 13. The method of clause 11, where input video units with same temporal level with the current video unit are not used for the filtering procedure, and/or where input video units with lower temporal level than the current video unit are not used for the filtering procedure, and/or where input video units with higher temporal level than the current video unit are not used for the filtering procedure.

Clause 14. The method of clause 10, where the input video units are defined according to quantization parameters (QPs).

Clause 15. The method of clause 14, where input video units with same QP with the current video unit are used for the filtering procedure, and/or wherein input video units with lower QP than the current video unit are used for the filtering procedure, and/or wherein input video units with higher QP than the current video unit are used for the filtering procedure.

Clause 16. The method of clause 14, wherein input video units with same QP with the current video unit are not used for the filtering procedure, and/or where input video units with lower QP than the current video unit are not used for the filtering procedure, and/or where input video units with higher QP than the current video unit are not used for the filtering procedure.

Clause 17. The method of clause 10, where input video units with a target slice type with current video unit are used for the filtering procedure.

Clause 18. The method of clause 10, where input video units with a target slice type with current video unit are not used for the filtering procedure.

Clause 19. The method of any of clauses 1-18, where a purpose of the filtering procedure comprises at least one of: resolution upsampling, picture rate upsampling, chroma upsampling, visual quality improvement, or bitdepth increase.

Clause 20. The method of any of clauses 1-3, where whether input video units to be used for the filtering procedure are available in a decoded picture buffer (DPB) is specified.

Clause 21. The method of clause 20, where a NNPFA SEI message or a NNPFC SEI message comprises a syntax element indicating whether all input video units used for the filtering procedure are available in the DPB.

Clause 22. The method of clause 21, where the syntax element is an NNPFC picture in decoding picture buffer (nnpfc_pic_in_dbp) syntax element.

Clause 23. The method of clause 20, where all input video units used for the filtering procedure are available in a DPB.

Clause 24. The method of clause 20, where if the input video units are not available in a DPB, the input video units are not used for the filtering procedure.

Clause 25. The method of any of clauses 1-3, where whether input video units to be used for the filtering procedure are reference pictures of the current video is specified.

Clause 26. The method of clause 25, where a NNPFA SEI message or a NNPFC SEI message comprises a syntax element indicating whether all input video units are refence video units or the current video unit.

Clause 27. The method of clause 26, where the syntax element is an NNPFC picture in reference picture list (nnpfc_pic_in_reflist) syntax element.

Clause 28. The method of clause 25, where all input video units used for the filtering procedure are reference video units of the current video unit or the current video unit.

Clause 29. The method of clause 25, where if the input video units are not reference video units of the current video unit or the current video unit, the input video units are not used for the filtering procedure.

Clause 30. The method of any of clauses 1-3, where a maximum picture buffer size needed for a storage of input and output video units of the filtering procedure is specified.

Clause 31. The method of clause 30, where a first maximum picture buffer size for the storage of the input video units of the filtering procedure is specified, and a second maximum picture buffer size for the storage of the output video units of the filtering procedure is specified.

Clause 32. The method of clause 31, where at least one of: the first maximum picture buffer size or the second maximum picture buffer size is smaller than or equal to a DPB size in the bitstream.

Clause 33. The method of clause 31, where a sum value of the first maximum picture buffer size and the second maximum picture buffer size is smaller than or equal to a DPB size in the bitstream.

Clause 34. The method of clause 31, where a NNPFA SEI message or a NNPFC SEI message comprises at least one of: a first syntax element indicating the first maximum picture buffer size for the storage of the input video units of the filtering procedure, a second syntax element indicating the second maximum picture buffer size for the storage of the output video units of the filtering procedure, a third syntax element indicating a difference between the first maximum picture buffer size and the DPB size, or a fourth syntax element indicating a difference between the second maximum picture buffer size and the DPB size.

Clause 35. The method of clause 34, where the first syntax element is an NNPFA maximum input picture buffer (nnpfa_max_input_pic_buffer) syntax element, and/or where the second syntax element is an NNPFA maximum output picture buffer (nnpfa_max_output_pic_buffer) syntax element, and/or where the third syntax element is an NNPFA maximum input picture buffer difference (nnpfa_max_input_pic_buffer_diff) syntax element, and/or where the fourth syntax element is an NNPFA maximum output picture buffer difference (nnpfa_max_output_pic_buffer_diff) syntax element.

Clause 36. The method of clause 30, where a maximum picture buffer size defines a total storage of the input video units and output video units of the filtering procedure.

Clause 37. The method of clause 36, where the maximum picture buffer size is smaller than or equal to a DPB size.

Clause 38. The method of clause 30, where a syntax element indicates the maximum picture buffer size.

Clause 39. The method of clause 30, where a syntax element indicates a difference between the maximum picture buffer size and a DPB size.

Clause 40. The method any of clauses 1-3, where a mechanism of upsampling a picture rate is specified.

Clause 41. The method of clause 40, where one or more sliding window mechanisms are employed for the filtering procedure.

Clause 42. The method of clause 41, where a syntax element is signalled to indicate that whether the sliding window mechanism is used.

Clause 43. The method of clause 40, where a syntax element is signalled to indicate that whether there are overlapped video units between a plurality of filtering processes with post-processing filters.

Clause 44. The method of clause 43, where a syntax element is signalled to indicate the number of overlapped of video units if there are one or more overlapped video units between the plurality of filtering processes with post-processing filters.

Clause 45. The method of clause 40, where a syntax element is signalled to indicate that whether there are gaps between a plurality of filtering processes with post-processing filters.

Clause 46. The method of clause 45, where a syntax element is signalled to indicate a gap size of video units if there are gaps between the plurality of filtering processes with post-processing filters.

Clause 47. The method of any of clauses 1-3, where a video unit which is not the current video unit to be input to the filtering procedure is indicted by a picture order count (POC) or a POC distance.

Clause 48. The method of clause 47, where the POC or the POC distance is determined by a displaying order.

Clause 49. The method of any of clauses 1-3, where a video unit which is not the current video unit to be input to the filtering procedure is indicted by decoding order index (DOI) or DOI distance.

Clause 50. The method of clause 49, where the DOI or the DOI distance is determined by a decoding order.

Clause 51. The method of any of clauses 1-3, where a video unit which is not the current video unit to be input to the filtering procedure is indicated by at least one of: a reference index or a reference list.

Clause 52. The method of any of clauses 1-51, where the conversion includes encoding the video unit into the bitstream.

Clause 53. The method of any of clauses 1-51, where the conversion includes decoding the video unit from the bitstream.

Clause 54. An apparatus for video processing comprising a processor and a non-transitory memory with instructions thereon, where the instructions upon execution by the processor, cause the processor to perform a method in accordance with any of clauses 1-53.

Clause 55. A non-transitory computer-readable storage medium storing instructions that cause a processor to perform a method in accordance with any of clauses 1-53.

Clause 56. A non-transitory computer-readable recording medium storing a bitstream of a video which is generated by a method performed by an apparatus for video processing, where the method comprises: determining which video unit is specified to be an input video unit of a filtering procedure that is applied to a current video unit of the video; and generating the bitstream based on the filtering procedure.

Clause 57. A method for storing a bitstream of a video, comprising: determining which video unit is specified to be an input video unit of a filtering procedure that is applied to a current video unit of the video; generating the bitstream based on the filtering procedure; and storing the bitstream in a non-transitory computer-readable medium.

### Example Device

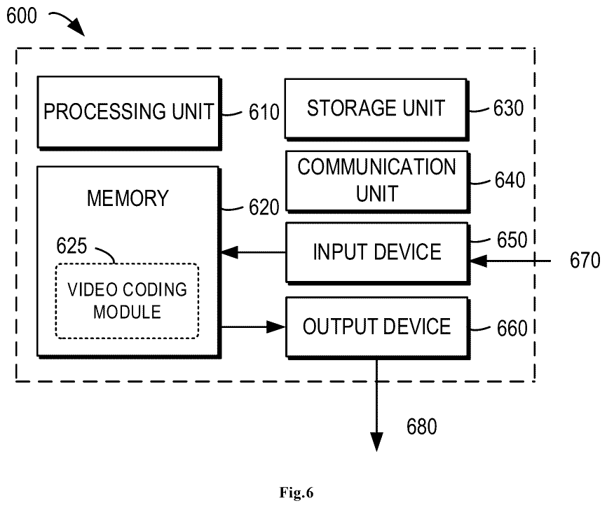

FIG. 6 illustrates a block diagram of a computing device 600 in which various embodiments of the present disclosure can be implemented. The computing device 600 may be implemented as or included in the source device 110 (or the video encoder 114 or 200) or the destination device 120 (or the video decoder 124 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement video encoding/decoding in embodiments of the present disclosure. The memory 620 may include one or more video coding modules 625 having one or more program instructions. These modules are accessible and executable by the processing unit 610 to perform the functionalities of the various embodiments described herein.

In the example embodiments of performing video encoding, the input device 650 may receive video data as an input 670 to be encoded. The video data may be processed, for example, by the video coding module 625, to generate an encoded bitstream. The encoded bitstream may be provided via the output device 660 as an output 680.

In the example embodiments of performing video decoding, the input device 650 may receive an encoded bitstream as the input 670. The encoded bitstream may be processed, for example, by the video coding module 625, to generate decoded video data. The decoded video data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a video unit of a video and a bitstream of the video, which video unit is specified to be an input video unit of a filtering procedure that is applied to a current video unit; and
performing the conversion based on the filtering procedure.

2. The method of claim 1, wherein the filtering procedure comprises one of:
a post-processing filtering procedure,
a neural network (NN)-based post processing filtering procedure,
an NN-based in-loop filtering procedure, or
a non-NN-based in-loop filtering procedure.

3. The method of claim 1, wherein the video unit comprises one of: a picture, a slice, a sub-picture, or a tile,
wherein the input video unit comprises one of: an input picture, an input slice, an input sub-picture, or an input tile. and
wherein the current video unit comprises one of: a current picture, a current slice, a current sub-picture, or a current tile.

4. The method of claim 1, wherein the current video unit is specified to be the input video unit of the filter, and/or
wherein a neural-network post-filter (NNPF) activation (NNPFA) supplemental enhancement information (SEI) message or a NNPF characteristics (NNPFC) SEI message comprises a syntax element indicating whether the current video unit is the only input video unit, and/or
wherein a NNPFA SEI message or a NNPFC SEI message comprises a syntax element indicating whether the input video unit comprises the current video unit, and/or
wherein at least the current video unit is employed as one of input video units of the filter, and/or
wherein input video units of the filtering procedure are defined according to a condition based on whether there is one or more input video units employed for the filtering procedure.

5. The method of claim 4, wherein the current video unit is the input video unit of the filter, if only one input video unit of the post-processing filter is supported, and/or
wherein the syntax element is an NNPFA input is the current picture (nnpfa_input_is_curr) syntax element, and/or
wherein the input video units are defined according to temporal layers, and/or
wherein the input video units are defined according to quantization parameters (QPs), and/or
wherein input video units with a target slice type with current video unit are used for the filtering procedure, and/or
wherein input video units with a target slice type with current video unit are not used for the filtering procedure.

6. The method of claim 5, wherein input video units with same temporal level with the current video unit are used for the filtering procedure, and/or
wherein input video units with lower temporal level than the current video unit are used for the filtering procedure, and/or
wherein input video units with higher temporal level than the current video unit are used for the filtering procedure, and/or
wherein input video units with same temporal level with the current video unit are not used for the filtering procedure, and/or
wherein input video units with lower temporal level than the current video unit are not used for the filtering procedure, and/or
wherein input video units with higher temporal level than the current video unit are not used for the filtering procedure.

7. The method of claim 6, wherein input video units with same QP with the current video unit are used for the filtering procedure, and/or
wherein input video units with lower QP than the current video unit are used for the filtering procedure, and/or
wherein input video units with higher QP than the current video unit are used for the filtering procedure, and/or
wherein input video units with same QP with the current video unit are not used for the filtering procedure, and/or
wherein input video units with lower QP than the current video unit are not used for the filtering procedure, and/or
wherein input video units with higher QP than the current video unit are not used for the filtering procedure.

8. The method of claim 1, wherein a purpose of the filtering procedure comprises at least one of: resolution upsampling, picture rate upsampling, chroma upsampling, visual quality improvement, or bitdepth increase, and/or
wherein whether input video units to be used for the filtering procedure are available in a decoded picture buffer (DPB) is specified, and/or
wherein whether input video units to be used for the filtering procedure are reference pictures of the current video is specified, and/or
wherein a maximum picture buffer size needed for a storage of input and output video units of the filtering procedure is specified.

9. The method of claim 8, wherein a NNPFA SEI message or a NNPFC SEI message comprises a syntax element indicating whether all input video units used for the filtering procedure are available in the DPB, and/or
wherein all input video units used for the filtering procedure are available in a DPB, and/or
wherein if the input video units are not available in a DPB, the input video units are not used for the filtering procedure, and/or
wherein a NNPFA SEI message or a NNPFC SEI message comprises a syntax element indicating whether all input video units are refence video units or the current video unit, and/or
wherein all input video units used for the filtering procedure are reference video units of the current video unit or the current video unit, and/or
wherein if the input video units are not reference video units of the current video unit or the current video unit, the input video units are not used for the filtering procedure.

10. The method of claim 9, wherein the syntax element is an NNPFC picture in decoding picture buffer (nnpfc_pic_in_dbp) syntax element, and/or
wherein the syntax element is an NNPFC picture in reference picture list (nnpfc_pic_in_reflist) syntax element.

11. The method of claim 8, wherein a first maximum picture buffer size for the storage of the input video units of the filtering procedure is specified, and a second maximum picture buffer size for the storage of the output video units of the filtering procedure is specified, and/or
wherein a maximum picture buffer size defines a total storage of the input video units and output video units of the filtering procedure, and/or
wherein a syntax element indicates the maximum picture buffer size, and/or
wherein a syntax element indicates a difference between the maximum picture buffer size and a DPB size.

12. The method of claim 11, wherein at least one of: the first maximum picture buffer size or the second maximum picture buffer size is smaller than or equal to a DPB size in the bitstream, and/or
wherein a sum value of the first maximum picture buffer size and the second maximum picture buffer size is smaller than or equal to a DPB size in the bitstream, and/or
wherein a NNPFA SEI message or a NNPFC SEI message comprises at least one of:
a first syntax element indicating the first maximum picture buffer size for the storage of the input video units of the filtering procedure,
a second syntax element indicating the second maximum picture buffer size for the storage of the output video units of the filtering procedure,
a third syntax element indicating a difference between the first maximum picture buffer size and the DPB size, or
a fourth syntax element indicating a difference between the second maximum picture buffer size and the DPB size, and/or
wherein the maximum picture buffer size is smaller than or equal to a DPB size.

13. The method of claim 12, wherein the first syntax element is an NNPFA maximum input picture buffer (nnpfa_max_input_pic_buffer) syntax element, and/or
wherein the second syntax element is an NNPFA maximum output picture buffer (nnpfa_max_output_pic_buffer) syntax element, and/or
wherein the third syntax element is an NNPFA maximum input picture buffer difference (nnpfa_max_input_pic_buffer_diff) syntax element, and/or
wherein the fourth syntax element is an NNPFA maximum output picture buffer difference (nnpfa_max_output_pic_buffer_diff) syntax element.

14. The method of claim 1, wherein a mechanism of upsampling a picture rate is specified, and/or
wherein a video unit which is not the current video unit to be input to the filtering procedure is indicted by a picture order count (POC) or a POC distance, and/or
wherein a video unit which is not the current video unit to be input to the filtering procedure is indicted by decoding order index (DOI) or DOI distance, and/or
wherein a video unit which is not the current video unit to be input to the filtering procedure is indicated by at least one of: a reference index or a reference list.

15. The method of claim 14, wherein one or more sliding window mechanisms are employed for the filtering procedure, and/or
wherein a syntax element is signalled to indicate that whether there are overlapped video units between a plurality of filtering processes with post-processing filters, and/or
wherein a syntax element is signalled to indicate that whether there are gaps between a plurality of filtering processes with post-processing filters, and/or
wherein the POC or the POC distance is determined by a displaying order, and/or
wherein the DOI or the DOI distance is determined by a decoding order.

16. The method of claim 15, wherein a syntax element is signalled to indicate that whether the sliding window mechanism is used, and/or
wherein a syntax element is signalled to indicate the number of overlapped of video units if there are one or more overlapped video units between the plurality of filtering processes with post-processing filters, and/or
wherein a syntax element is signalled to indicate a gap size of video units if there are gaps between the plurality of filtering processes with post-processing filters.

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to perform a method, wherein the method comprises:
determining, for a conversion between a video unit of a video and a bitstream of the video, which video unit is specified to be an input video unit of a filtering procedure that is applied to a current video unit; and
performing the conversion based on the filtering procedure.

19. A non-transitory computer-readable storage medium storing instructions that cause a processor to perform a method, wherein the method comprises:
determining, for a conversion between a video unit of a video and a bitstream of the video, which video unit is specified to be an input video unit of a filtering procedure that is applied to a current video unit; and
performing the conversion based on the filtering procedure.

20. A non-transitory computer-readable recording medium storing a bitstream of a video which is generated by a method performed by an apparatus for video processing, wherein the method comprises:
determining which video unit is specified to be an input video unit of a filtering procedure that is applied to a current video unit of the video; and
generating the bitstream based on the filtering procedure.
